(19) United States
(12) Patent Application Publication
(10) Pub. No.: US 2018/0251103 A1
(43) Pub. Date: Sep. 6, 2018

(54) VEHICLE BRAKE SYSTEMS

(71) Applicant: JAGUAR LAND ROVER LIMITED, Whitley, Coventry, Warwickshire (GB)

(72) Inventors: Anthony SATTERTHWAITE, Solihull, West Midlands (GB); Guy BATES, Leamington Spa, Warwickshire (GB); Philip FERDANI, Claydon, Oxfordshire (GB)

(21) Appl. No.: 15/760,107

(22) PCT Filed: Sep. 9, 2016
(86) PCT No.: PCT/EP2016/071279

§ 371 Date: Mar. 14, 2018

(30) Foreign Application Priority Data
Sep. 14, 2015 (GB) 1516196.1

(51) Int. Cl. B60T 1/10; B60T 13/58; B60T 17/22; F16D 61/00; F16D 65/00; F16D 66/02

(52) U.S. Cl. CPC B60T 1/10; B60T 13/586; B60T 17/221; B60T 2270/604; F16D 65/0037; F16D 65/0043; F16D 66/022; F16D 61/00

(57) ABSTRACT

A method of operating a vehicle braking system comprising one or more frictional braking devices and one or more regenerative braking devices. The method comprises receiving one or more electrical signals indicative of a brake command. The method further comprises determining whether one or more predetermined conditions are met in response to the received brake command, wherein at least one of the predetermined condition(s) comprises a condition pertaining to the one or more frictional braking devices. The method still further comprises inhibiting the operation of at least one of the one or more regenerative braking devices and actuating at least one of the one or more frictional braking devices when at least certain of the one or more predetermined conditions are met in order to carry out the received brake command and to also bed-in brake pad lining(s) of the actuated frictional braking devices.

### TECHNICAL FIELD

The present disclosure relates to vehicle brake systems having both regenerative and frictional braking devices and particularly, but not exclusively, to automatically controlling the operation of such a vehicle brake system to allow for the bedding-in of the frictional braking device(s) of the system. Aspects of the invention relate to a method, to a non-transitory computer-readable storage medium, to a system, to a vehicle, to a vehicle braking system, and to an electronic controller.

### BACKGROUND

It is known that vehicle braking systems may include both regenerative and frictional braking devices. It is common in such systems for the regenerative braking devices to almost exclusively perform the braking functions, with the frictional braking devices being used only sparingly when, for example, the vehicle is travelling at very low speeds where regenerative braking is typically less effective, or there is a problem with one or more of the regenerative braking devices, or if the breaking force required is very high as may be the case in an emergency stop event.

One disadvantage of braking systems having both regenerative and frictional braking capabilities relates to the bedding-in of brake pad linings of the frictional braking devices. More particularly, for a frictional braking device with a green (e.g., new) lining, a bedding-in process is required to be performed on the lining before the friction interface of the frictional braking device functions in an optimal and efficient manner. Braking devices having linings that are insufficiently bedded-in may experience less than desirable braking performance, noise, vibration, and harshness (NVH) performance, and/or other adverse affects or consequences.

The bedding-in process for a frictional braking device is typically performed as the braking device is actuated during normal operation of the vehicle and a brake torque is applied by braking device to an axle to which it is operatively coupled. However, because the regenerative braking device(s) are predominantly used to the exclusion of the frictional braking device(s) in many regenerative/frictional braking systems, the required bedding-in process may be delayed due to a lack of use of the frictional braking devices. As a result, optimal and efficient performance of the frictional braking devices may also be delayed (i.e., until the linings are sufficiently bedded-in through use).

Accordingly, it is an aim of the present invention to address, for example, the disadvantages identified above.

### SUMMARY OF THE INVENTION

According to one aspect of the invention for which protection is sought, there is provided a method of operating a vehicle braking system comprising one or more frictional braking devices and one or more regenerative braking devices. In an embodiment, the method comprises: receiving one or more electrical signals indicative of a brake command; determining whether one or more predetermined conditions are met in response to the received brake command, wherein at least one of the predetermined condition(s) comprises a condition pertaining to the one or more frictional braking devices; and when at least certain of the one or more predetermined conditions are met, inhibiting the operation of at least one of the one or more regenerative braking devices and actuating at least one of the one or more frictional braking devices in order to carry out the received brake command and to bed-in brake pad lining(s) of the actuated frictional braking devices.

According to another aspect of the invention for which protection is sought, there is a provided a system for controlling the operation of a vehicle braking system comprising one or more frictional braking devices and one or more regenerative braking devices. In an embodiment, the system comprises means for receiving one or more electrical signals indicative of a brake command; means for determining whether one or more predetermined conditions are met in response to the received brake command, wherein at least one of the predetermined condition(s) comprises a condition pertaining to the one or more frictional braking devices; and means for commanding that the operation of at least one of the one or more regenerative braking devices be inhibited and that at least one of the one or more frictional braking devices be actuated when at least certain of the one or more conditions are met in order to carry out the received brake command and to bed-in brake pad lining(s) of the actuated frictional braking device(s).

In an embodiment, the receiving, determining, and commanding means comprise an electronic processor having an electrical input for receiving the one or more signals indicative of the brake command, and an electronic memory device electrically coupled to the electronic processor. The electronic processor is configured to access the memory device and to execute the instructions stored therein such that it is configured to: receive the one or more signals indicative of a brake command; determine whether the one or more predetermined conditions are met in response to the received brake command; and automatically command that the operation of the at least one regenerative braking device be inhibited and that the at least one frictional braking device be actuated when the at least certain of the one or more predetermined conditions are met in order to carry out the received brake command and to bed-in the brake pad lining(s) of the actuated frictional braking device(s).

According to a still further aspect of the invention for which protection is sought, there is provided an electronic controller for a vehicle having a storage medium associated therewith storing instructions thereon that when executed by the controller causes a vehicle braking system having one or more regenerative braking devices and one or more frictional braking devices to be operated in accordance with the method of: receiving one or more electrical signals indicative of a brake command; determining whether one or more predetermined conditions are met in response to the received brake command, wherein at least one of the predetermined condition(s) comprises a condition pertaining to the one or more frictional braking devices; and when at least certain of the one or more predetermined conditions are met, inhibiting the operation of at least one of the one or more regenerative braking devices and actuating at least one of the one or more frictional braking devices in order to carry out the brake command and bed-in brake pad lining(s) of the actuated frictional braking devices.

According to yet another aspect of the invention for which protection is sought, there is provided a vehicle comprising the system or electronic controller described herein.

According to a further aspect of the invention for which protection is sought, there is provided a vehicle braking system comprising the system or electronic controller described herein.

According to a further aspect of the invention for which protection is sought, there is provided a non-transitory, computer-readable storage medium storing instructions thereon that when executed by one or more electronic processors causes the one or more processors to carry out the method described herein.

Optional features of the various aspects of the invention are set out below in the dependent claims.

At least some embodiments of the present invention have an advantage, among potentially others, that in an instance wherein a vehicle has a braking system comprised of both regenerative and frictional braking devices, and the regenerative braking devices thereof perform the vast majority of the braking functionality of the braking system, operation of some or all of the regenerative braking devices may be inhibited and some or all of the frictional braking devices may be actuated in response to a brake command to allow a bedding-in process to be performed on brake pad lining(s) of the actuated frictional braking devices while simultaneously carrying out the brake command. As a result, the lining(s) of the frictional braking device(s) are bedded-in a shorter amount of time than it would ordinarily take if, for example, operation of the regenerative braking devices was not inhibited, and thus, efficient and optimal performance of the frictional braking devices is achieved in a shorter amount of time.

Within the scope of this application it is expressly intended that the various aspects, embodiments, examples and alternatives set out in the preceding paragraphs, in the claims and/or in the following description or drawings, and in particular the individual features thereof, may be taken independently or in any combination. That is, all embodiments and/or features of any embodiment can be combined in any way and/or combination, unless such features are incompatible. The applicant reserves the right to change any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the following figures in which:

FIG. 1 is a side view of an illustrative embodiment of a vehicle having a braking system comprised of both frictional and regenerative braking subsystems and a controller;

FIG. 2 is a schematic and block diagram of an illustrative embodiment of a vehicle such as, for example, that illustrated in FIG. 1, having a braking system comprised of both frictional and regenerative braking subsystems; and

FIG. 3 is a flow diagram depicting various steps of an illustrative embodiment of a method of operating a vehicle braking system comprising one or more frictional braking devices and one or more regenerative braking devices, such as, for example, the braking system illustrated in FIG. 2.

### DETAILED DESCRIPTION

The systems and methods described herein may be used to automatically control the operation of a brake system of a vehicle having one or more regenerative braking devices and one or more frictional braking devices. In an embodiment, the present systems and methods receive one or more electrical signals indicative of a brake command, determine whether one or more predetermined conditions are met in response to the received brake command, and inhibit the operation of at least one of the one or more regenerative braking devices and actuate at least one of the one or more frictional braking devices when it is determined that the one or more predetermined conditions are met.

References herein to a block such as a function block are to be understood to include reference to software code for performing the function or action specified in which an output is provided responsive to one or more inputs. The code may be in the form of a software routine or function called by a main computer program, or may be code forming part of a flow of code not being a separate routine or function. Reference to function blocks is made for ease of explanation of the manner of operation of a control system according to an embodiment of the present invention.

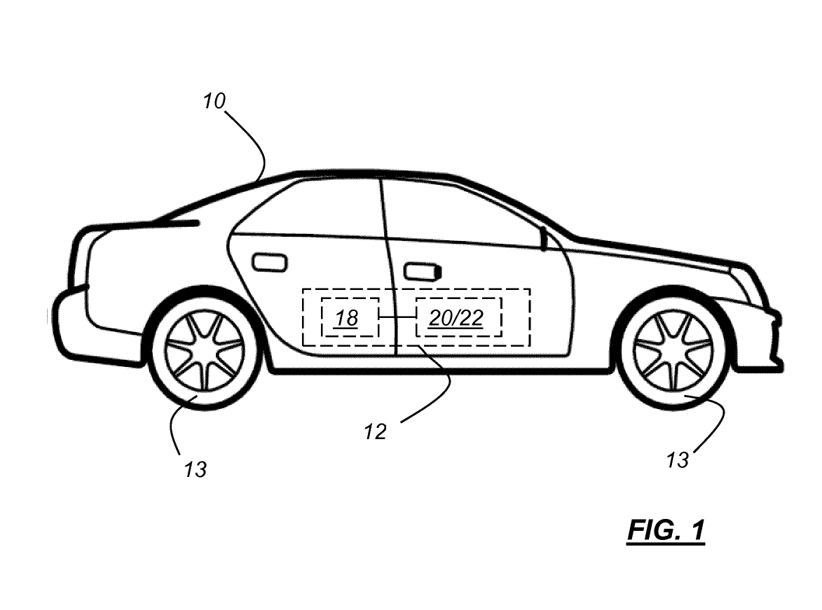

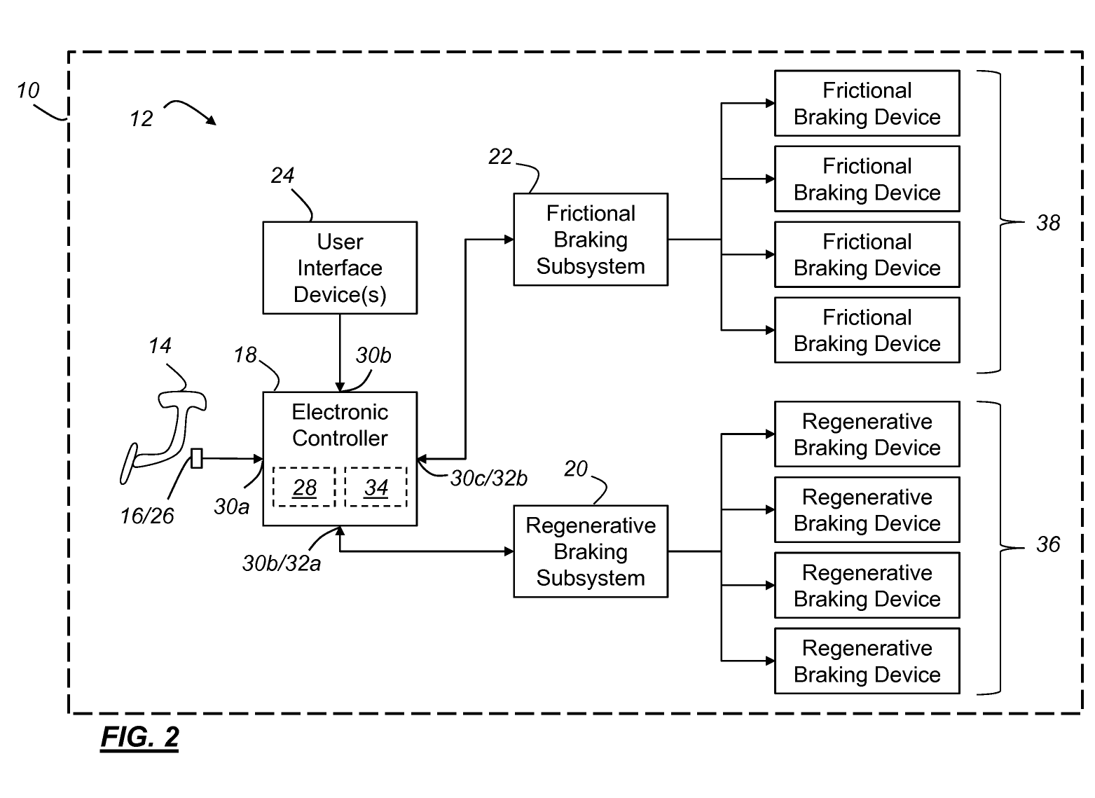

With reference to FIGS. 1 and 2, there is shown a vehicle 10 comprising, among other components, a braking system 12 having both regenerative and frictional braking capabilities (i.e., regenerative and frictional braking devices) for generating a brake torque that is applied to one or more axles and/or one or more ground engaging wheels (e.g., wheels 13 in FIG. 1) of vehicle 10 to slow or stop the progress of vehicle 10 in use. It will be appreciated that the braking system 12 may include any number of vehicle braking systems having both regenerative and frictional capabilities, including, for example and without limitation, an electro-mechanical braking (EMB) system and an electro-hydraulic braking (EHB) system, to cite just two possibilities. The braking system 12, and the system(s) and method(s) described below, may find application with any number of vehicles, including traditional vehicles, hybrid electric vehicles (HEVs), extended-range electric vehicles (EREVs), battery electrical vehicles (BEVs), passenger cars, sports utility vehicles (SUVs), cross-over vehicles, and trucks, to cite a few possibilities. Accordingly, the braking system 12 is not limited to any particular braking system having regenerative and frictional braking capabilities, or to use with any particular type of vehicle. According to an embodiment, the braking system 12 generally includes a brake pedal 14, one or more sensors 16, a control means in the form of an electronic control unit or controller 18, a regenerative braking subsystem 20, a frictional braking subsystem 22, and one or more user interface devices 24, among any number of other components, systems, and/or devices that may or may not be illustrated or otherwise described herein.

As is well known in the art, the brake pedal 14 may be used by the driver of the vehicle 10 to manually input brake commands to the braking system 12. In an embodiment, movement of the brake pedal 14 may be monitored by at least one of the one or more sensors 16 to detect that a brake command has been input via the pedal 14, and, in at least some implementations, to detect one or more characteristics relating to the brake command (e.g., speed, severity, force, etc., of the command). Depending on the implementation, the brake pedal 14 may be operatively coupled (i.e., either directly coupled or indirectly coupled through one or more intermediate components) to, for example, a master cylinder of the frictional braking subsystem 22, a brake pedal simulator or emulator, or to some other component of the braking system 12.

The sensor(s) 16 are configured to provide information that may be utilized in the operation of the braking system 12, and, in at least some embodiments, the performance of one or more steps of the method(s) described herein. The sensors described herein, including the sensor(s) 16, may comprise any number of different types of sensors, components, devices, modules, systems, etc., configured to monitor, sense, detect, measure, or otherwise determine a variety of parameters, and that the sensors may directly sense or measure the conditions or parameters for which they are provided, or may indirectly evaluate such conditions/parameters based on information provided by other sensors, components, devices, modules, systems, etc. Additionally, the sensor(s) may be integrated within a vehicle component, device, module, subsystem, etc., may be stand-alone components, or may be provided according to some other suitable arrangement. Further these sensors may be directly coupled to the electronic controller 18, indirectly coupled thereto via other electronic devices (e.g., a controller area network (CAN) bus, a system management bus (SMBus), a proprietary communication link, or using another suitable communication technique), or coupled in accordance with some other suitable arrangement known in the art. In an embodiment, one or more sensors 16 are configured to provide an electrical signal indicative of a brake command. An example of such a sensor is a brake pedal sensor 26. As the name would suggest, the brake pedal sensor 26 is configured to provide one or more electrical signals to, for example, the electronic controller 18 of the brake system 12, that is/are representative of one or more of the position, movement, exerted force, and/or state of the brake pedal 14. In any event, the signal(s) provided by the brake pedal sensor 26 is/are representative of a brake command, for example, a driver-initiated brake command. In an embodiment, the system 12 may include a single brake pedal senor 26, while in other embodiments the system 12 may include multiple brake pedal sensors 26 that may be configured to sense, measure, detect, etc. the same or different parameter(s) and/or condition(s). Each brake pedal sensor 26 may comprise any number of suitable sensors known in the art, including, for example and without limitation, one or more of: an optical sensor, an electro-magnetic sensor, a contact switch, a potentiometer, and/or a force sensor, to cite a few possibilities.

It will be appreciated that while one particular sensor 16 (i.e., brake pedal sensor 26) has been described above, in at least some embodiments, one or more additional or alternative sensors may be provided that are suitable to detect and/or provide electrical signals indicative of a brake command. For example, the sensor(s) 16 may additionally or alternatively comprise one or more brake torque sensors, brake pressure sensors, and/or other suitable sensors. Accordingly, the braking system 12 is not limited to any particular type(s) or number of sensors 16.

As briefly described above, and as illustrated in FIG. 2, the braking system 12 further includes a control means in the form the electronic controller 18. The controller 18 may include any combination of electronic processing devices, electronic memory devices, input/output (I/O) devices, and/or other known components, and may be configured to, among other things, receive information from the sensor(s) 16 (e.g., the brake pedal sensor 26) and to perform various control and/or communication related functions, including, in at least some embodiments, all or part of the functionality required for carrying out the method described herein. For example, in an embodiment, the controller 18 is configured to receive information from the brake pedal sensor 26 and in dependence thereon, exert a measure of control over the operation of the regenerative braking subsystem 20 and/or the frictional braking system 22 to cause an appropriate amount of braking torque (i.e., frictional braking torque, regenerative braking torque, or a blend of frictional and regenerative braking torque) to be applied to one or more axles of the vehicle 10 in order to carry out the brake command. It is to be understood that the controller 18 can comprise a control unit or computational device having one or more electronic processors (e.g., a microprocessor, a microcontroller, an application specific integrated circuit (ASIC), etc.), and that the braking system 12 may comprise a single controller or control unit, or alternatively different functions of the controller 18 may be embodied in, or hosted in, different controllers or control units. As used herein, the term “controller” or “control unit” will be understood to include both a single controller or control unit and a plurality of controllers and control units collectively operating to provide the required control functionality. A set of instructions could be provided which, when executed, cause the controller 18 to implement the control techniques described herein (including some or all of the functionality of the method described herein). The set of instructions could be embedded in said one or more electronic processors of the controller 18; or alternatively, the set of instructions could be provided as software to be executed in the controller 18. A first controller or control unit may be implemented in software run on one or more processors. One or more other controllers or control units may be implemented in software run on one or more processors, optionally the same one or more processors as the first controller or control unit. Other arrangements are also useful.

In an illustrative embodiment such as that shown in FIG. 2, the controller 18 comprises an electronic processor 28 having one or more electrical inputs 30 (e.g., inputs 30a, 30b, 30c, and 30d) and one or more electrical outputs 32 (e.g., outputs 32a and 32b). The electronic processor 28 may comprise any suitable electronic processor (e.g., a microprocessor, a microcontroller, an ASIC, etc.) that is configured to execute electronic instructions. The controller 18 further includes an electronic memory device 34 that is either part of or electrically connected to and accessible by the processor 28. The electronic memory device 34 may comprise any suitable memory device and may store a variety of data, information, and/or instructions therein or thereon. In an embodiment, the memory device 34 has information and instructions for software, firmware, programs, algorithms, scripts, applications, etc. stored therein or thereon that may govern all or part of the methodology described herein. The processor 28 may access the memory device 34 and execute and/or use that or those instructions and information to carry out or perform some or all of the functionality and methodology describe herein. Alternatively, some or all of the aforementioned instructions/information may be embedded in a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

In addition to the above, the controller 18 may also be electronically connected to other components of the braking system 12 (e.g., the sensor(s) 16, the regenerative braking subsystem 20, the frictional braking subsystem 22, and/or the user interface device(s) 24) or the vehicle 10 via any suitable wireless or wired communications (e.g., CAN bus, SMBus, a proprietary communication link, or through some other arrangement known in the art) and can interact with them when or as required.

Depending on the particular implementation of the braking system 12 and/or the vehicle 10, the controller 18 may be a standalone unit dedicated to the braking system 12, may be part of a larger system of the vehicle 10, may be integrated into another electronic control unit or controller of the vehicle 10 (e.g., the functionality of the ECU 18 may be integrated into a controller or control unit of a system of the vehicle 10 other than the braking system 12, an integrated vehicle control unit (VCU), or the like), or may be provided in accordance with some other suitable arrangement.

With continued reference to FIG. 2, the regenerative braking subsystem 20 may generally comprise any regenerative braking system or subsystem known in the art that is configured to generate a regenerative braking torque and to apply that generated braking torque to one or more axles and/or one or more ground engaging wheels associated with said axles of the vehicle 10. More particularly, the regenerative braking subsystem 20 may include one or more regenerative braking devices 36 operatively coupled to one or more drivetrain or driveline components of the vehicle 10 (e.g., output shafts, axles, vehicle wheels, etc.) that is/are configured to generate and apply a braking torque to that or those components, and thus, directly or indirectly to one or more axles of the vehicle 10. The regenerative braking device(s) 36 may comprise any suitable regenerative braking devices known in the art. In an illustrative embodiment, each regenerative braking device 36 comprises an electric motor that when operated in a reverse direction functions as a generator and creates an electromagnetically-derived torque that when applied to an axle of the vehicle 10, acts as a braking torque thereon. It will be appreciated that the regenerative braking subsystem 20 may include a single regenerative braking device configured to apply a braking torque to one axle of the vehicle 10, or may include a plurality of regenerative braking devices that collectively apply braking torque to one or more axles of the vehicle 10. In the latter instance, the regenerative braking devices may be operated in unison or may be operated individually on a device-by-device basis (e.g., in certain instances, one or more but less than all of braking devices may be operated at a given time). Accordingly, it will be appreciated that the present invention is not limited to any particular number or arrangement(s) of regenerative braking devices 36.

In an embodiment, operation of the regenerative braking devices 36 of the subsystem 20 is controlled directly by the controller 18 of the braking system 12. In such an embodiment, when operation of one or more of the regenerative braking devices 36 is needed (i.e., in dependence on a received brake command), the controller 18 sends an electrical command signal to the appropriate braking device(s) 36, causing a braking torque to be applied to one or more axles of the vehicle 10 by that or those braking devices. In another embodiment, the regenerative braking subsystem 20 may include a dedicated electronic control unit or controller (not shown) for controlling the operation of the regenerative braking devices 36. In such an embodiment, the control unit of the subsystem 20 may be electrically connected to, configured for communication with, and operate under the control of the controller 18. For example, in response to a brake command, the controller 18 may send a command signal to the control unit of the regenerative braking subsystem 20 in response to which the control unit may cause one or more of the regenerative braking devices 36 to generate and apply a braking torque to one or more axles of the vehicle 10. It will therefore be appreciated that the present invention is not intended to be limited to any particular scheme or arrangement for controlling the operation of the regenerative braking subsystem 20, as any number of suitable schemes or arrangements may be used.

The frictional braking subsystem 22 may generally comprise any frictional braking system or subsystem known in the art that is configured to generate a frictional braking torque and to apply that generated braking torque to one or more axles and/or one or more ground engaging wheels associated with said axles of the vehicle 10. As with the regenerative braking subsystem 20, the frictional braking subsystem 22 may include one or more frictional braking devices operatively coupled to one or more drivetrain or driveline components of the vehicle 10 (e.g., output shafts, axles, vehicle wheels, etc.) that is/are configured to generate and apply a braking torque to that or those components, and thus, directly or indirectly to one or more axles of the vehicle 10. For purposes of illustration only, the frictional braking subsystem 22 will be hereinafter described in the context of a hydraulic-based frictional braking subsystem. It will be appreciated however that the frictional braking subsystem 22 is not intended to be limited to any particular type(s) of frictional braking systems, as any suitable system may be used. For example, it will be appreciated that a pneumatic-actuated frictional braking system may be used additionally or as an alternative to the hydraulically-actuated frictional braking system described herein. A pneumatically-actuated frictional braking system, such as air brakes, may be better suited for heavy vehicle applications, such as, for example, commercial vehicles like trucks and buses.

As will be appreciated by one having ordinary skill in the art, the hydraulic-based frictional braking subsystem 22 may include, among other components, a master cylinder assembly, one or more brake or hydraulic lines, and one or more frictional braking devices (devices 38 shown in FIG. 2) each of which is operatively coupled to an axle of the vehicle 10 (i.e., either directly coupled or indirectly coupled through one or more intermediate components) and configured to generate and apply braking torque to an axle of the vehicle 10.

The braking device(s) 38 may include any number of frictional braking devices, including those associated with disc brakes, drum brakes, and any other suitable frictional braking system. In an illustrative embodiment, however, each frictional braking device 38 comprises a caliper, a caliper piston, a pair of brake pads each having a lining comprising a friction material, and a brake disc (also called a rotor) that is operatively coupled to an axle of the vehicle 10. As is known in the art, the caliper straddles the rotor and carries the caliper piston so that a frictional braking torque can be applied by the brake pads to opposing sides of the rotor and hence to the axle to which the braking device is coupled. More particularly, when a particular frictional braking device 38 is to be actuated, a force is applied onto a piston in the master cylinder assembly that, in turn, causes fluid from a brake fluid reservoir to flow into the master cylinder. This results in an increase in fluid pressure in the frictional braking subsystem 22 (i.e., also referred to as “brake pressure”) and results in brake or hydraulic fluid being forced through a hydraulic line coupled to the braking device being actuated. When the fluid reaches the braking device, the caliper piston thereof applies a force to the caliper, urging the brake pads into engagement with the rotor. Friction between the brake pads and rotor results in a frictional brake torque being applied to the axle to which the rotor is coupled. It will be appreciated that frictional braking devices may be operated in unison or may be operated individually on a device-by-device basis (e.g., in certain instances, one or more but less than all of braking devices may be operated at a given time). In any event, it will be appreciated that while a description of one particular example of a frictional brake system or subsystem has been provided, the present invention is not intended to be limited to any one particular type(s) of frictional brake subsystem.

In an embodiment, operation of the frictional braking subsystem 22, and thus, the frictional braking devices 38, is controlled directly by the controller 18 of the braking system 12. In such an embodiment, when operation of one or more of the frictional braking devices 38 is desired or needed (i.e., in dependence on a received brake command), the controller 18 sends an electrical command signal to an actuator associated with the appropriate braking device(s) 38, causing a braking torque to be applied to one or more axles of the vehicle 10 by that or those braking devices. In another embodiment, the frictional braking subsystem 22 may include a dedicated electronic control unit or controller (not shown) for controlling the operation of the frictional braking devices 38. In such an embodiment, the control unit of the subsystem 22 may be electrically connected to, configured for communication with, and operate under the control of the controller 18. For example, in response to a brake command, the controller 18 may send a command signal to the control unit of the frictional braking subsystem 22 in response to which the control unit may cause one or more of the frictional braking devices 38 to generate and apply a braking torque to one or more axles of the vehicle 10. It will therefore be appreciated that the present invention is not intended to be limited to any particular scheme or arrangement for controlling the operation of the frictional braking subsystem 22, as any number of suitable schemes or arrangements may be used.

As briefly described above, the braking system 12 may further include one or more user interface devices 24 that may be used by a user (e.g., driver, service technician, dealer personnel, manufacturer personnel, etc.) to interact with the system 12, and the controller 18 thereof, in particular. For example, these devices may allow a user to initiate or activate a bedding-in process to be performed on one or more of the frictional braking devices 38 of the frictional braking subsystem 22. The user interface device(s) 24 may take any number of forms, such as, for example and without limitation, one or a combination of: a pushbutton; a knob; a switch; a touch screen; a visual display; a speaker; a heads-up display; a keypad; a keyboard; or any other suitable device. Additionally, these devices may be located at any number of locations about the vehicle, for example, within the vehicle cabin and in relatively close proximity to the driver (e.g., steering wheel, steering column, dashboard, center console, etc.). Additionally or alternatively, the user interface(s) 24 may be provided via a vehicle mounted diagnostic port in communication with an appropriately configured vehicle diagnostics tools, which may be placed in communication with the vehicle 10 during or following regular vehicle maintenance, for example, during regularly scheduled vehicle service intervals. The diagnostics tool may be used to read and clear any fault codes that may have been generated and stored by the vehicle 10 prior to the scheduled maintenance. The diagnostics tool may be further configured to provide service personnel means to initiate or activate a bedding-in process to be performed on one or more of the frictional braking devices 38 of the frictional braking subsystem 22.

In an embodiment, the user input device(s) 24 may be electrically connected to and configured for communication with the controller 18 either directly or indirectly through one or more other components of the vehicle 10 or the braking system 12 (e.g., CAN bus, SMBus, a proprietary communication link, or through some other arrangement known in the art). The communications link may be a wireless means of communication with the vehicle 10, such as, for example, Wi-Fi or other wireless interface as may be suitable to perform a remote over-the-air vehicle system diagnostic and/or software update. Additionally, in an embodiment, the user interface device(s) 24 may be standalone devices dedicated for use with the braking system 12, while in other embodiments, the user interface(s) 24 may be shared device(s) that is/are configured to allow a user to provide inputs relating to any number of vehicle features or functions. As such, the present invention is not intended to be limited to any particular type, number, or arrangement of the user interface devices 24.

In an embodiment, the braking system 12 may be operable in a number of different operational modes. In a first mode, which may be considered a “normal” mode of operation, the braking system 12 may operate in a conventional manner in which the regenerative braking subsystem 20 performs a majority of the brake function of the braking system 12, or a blend of regenerative braking torque and frictional braking torque is applied to one or more axles of the vehicle 10 by the regenerative braking subsystem 20 and the frictional braking subsystem 22. In this first mode, vehicle configuration is optimized for regenerative braking, and energy recovery during braking is the priority. In a second mode, which may be considered to be a “factory” or “service” mode (or a factory- or service-enabled mode), operation of one or more of the regenerative braking devices 36 of the regenerative braking subsystem 20 may be inhibited in favor of actuation of one or more of the frictional braking devices 38 to facilitate a bedding-in process to be performed on brake pad lining(s) of the actuated frictional braking devices 38. In this second mode, the vehicle 10 is temporarily configured to facilitate efficient bedding-in of the friction brakes, prioritizing frictional-based braking over regenerative braking at the expense of energy recovery. The second or factory mode may be activated or enabled by the manufacturer or dealer prior to the vehicle 10 being received by a customer, or may be activated by the manufacturer or a service technician upon the servicing of the brake system 12 and the frictional braking subsystem 22, in particular. In an embodiment, the second mode remains active until it is manually deactivated or automatically deactivated in dependence on certain criteria being met that is/are indicative of a brake bedding-in process being complete (e.g., at least certain of one or more conditions described below with respect to the method of operating the braking system 12 not being met). In any event, while two examples of operating modes for the braking system 12 have been identified above, it will be appreciated that the present invention is not limited to only those two modes, as braking system may certainly be operated in one or more additional or alternative modes.

In addition to the braking system 12 described above, it will be appreciated that the vehicle 10 may include a variety of other systems, components, devices, etc. For example, the vehicle 10 may include a number of sensors in addition to the sensor(s) 16 of the braking device 12, including, for example and without limitation, any one or more of: wheel speed sensor(s); gyro sensor(s) to detect yaw, roll, and pitch of the vehicle; vehicle speed sensor(s); longitudinal acceleration sensor(s); engine torque sensor(s); driveline torque sensor(s); throttle valve sensor(s); lateral acceleration sensor(s); vertical acceleration sensor(s); accelerator pedal position sensor(s); air suspension sensor(s) (i.e., ride height sensors); wheel position sensor(s); wheel articulation sensor(s); vehicle body vibration sensor(s), among others known in the art.

As is known in the art, the vehicle 10 may further include any number of systems, for example, a powertrain system, an electronic drive system, a chassis management or control system, a steering system, a driveline system, a progress or speed control system (e.g., a cruise control system and/or a hill descent control system) to cite a few possibilities; as well as any number of components or modules that may or may not be part of a larger system, for example, an integrated vehicle control unit (VCU) and an ignition module, to cite only two possibilities.

For the purposes of this invention, each of the aforementioned sensors, systems, and components/modules and the functionality corresponding thereto is conventional in the art. As such, detailed descriptions will not be provided; rather, the structure and function of each identified sensor, system, and component/module will be readily apparent to those having ordinary skill in the art.

The preceding description of the vehicle 10 and the braking system 12, and the illustration in FIGS. 1 and 2 are only intended to illustrate one vehicle and braking system arrangement, and to do so in a general way. It is certainly contemplated that any number of other arrangements and architectures, including those that differ significantly from the one shown in FIG. 2, may be used instead.

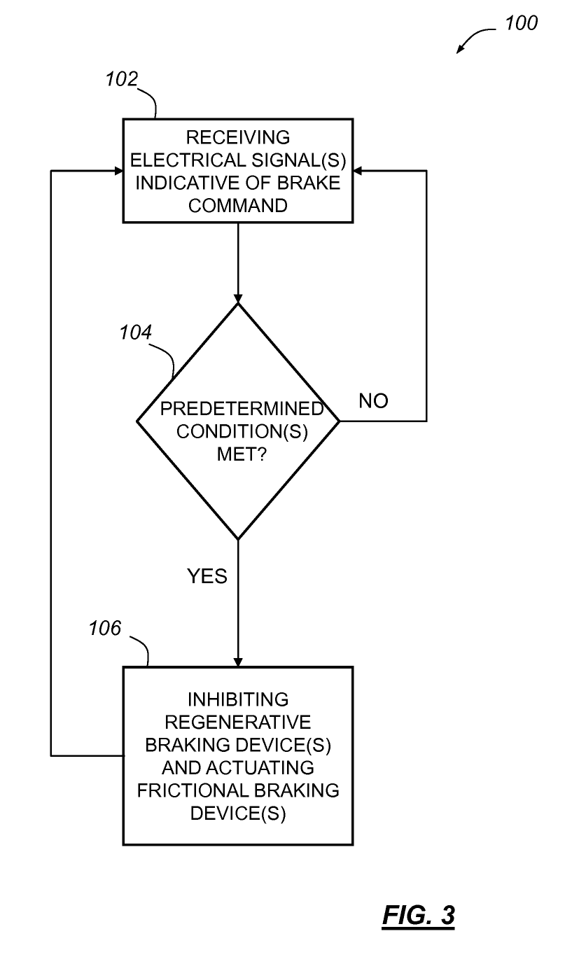

Turning now to FIG. 3, there is shown an example of a method 100 of controlling the operation of a vehicle braking system having both regenerative and frictional braking devices. For purposes of illustration and clarity only, the method 100 will be described in the context of the vehicle 10 described above, and the brake subsystem 12 thereof illustrated in FIG. 2, in particular. It will be appreciated, however, that the application of the present methodology is not meant to be limited solely to such an arrangement. Rather, the method 100 may find application with any number of arrangements (i.e., the steps of the method 100 may be performed by systems or components of the vehicle 10 or the brake system 12 other than that or those described herein, or vehicle/brake system arrangements other than that or those described above.) Additionally, it will be appreciated that unless otherwise noted, the performance of the method 100 is not meant to be limited to any one particular order or sequence of steps or to any particular component(s) for performing the steps.

In an embodiment, the method 100 includes a step 102 of receiving one or more electrical signals indicative of a brake command. The electrical signal(s) received in step 102 may be received from a number of sources including, in an embodiment, a component of the braking system 12. More particularly, one or more electrical signals may be received from a sensor 16 of the braking system 12, for example, the brake pedal sensor 26 that is configured to detect one or more parameters indicative of a driver-initiated brake command. Additionally or alternatively, the electrical signal(s) may be received from a system or component of the vehicle 10 that is separate and distinct from the braking system 12. For example, in certain instances, one or more systems or components of the vehicle 10 may be configured to determine that braking of the vehicle 10 is necessary or desirable, and to generate a command that is sent or communicated to the braking system 12 to effect the desired braking. These systems may include, for example and without limitation, a cruise control system, a hill descent control system, a vehicle stability control system, and a VCU of the vehicle, to cite only a few possibilities. Accordingly, it will be appreciated that the brake command received in step 102 may be indicative of either a user-initiated or vehicle system/component-initiated brake command, and that the present disclosure is not intended to be limited to any particular source from which the electrical signal(s) indicative of a brake command is/are received in step 102.

In an embodiment, the controller 18 of the braking system 12 is configured to receive the electrical signal(s) in step 102 (at, for example, and input 30 (e.g., input 30a in FIG. 2) of the controller 18); though in other embodiments, different components of the braking system 12 (e.g., control units of the regenerative braking subsystem 20 and/or the frictional braking subsystem 22) or vehicle 10 (e.g., a VCU) may be configured to do so.

In response to the signal(s) received in step 102, method 100 may move to a step 104 of determining whether one or more predetermined conditions are met. Any number of conditions may be evaluated or considered in step 104 including at least one condition pertaining to one or more of the frictional braking devices 38 of the braking system 12, such as, for example and without limitation, one or more of the conditions described below.

One condition that may be evaluated in step 104 is whether a request to perform a bedding-in process on the frictional braking devices 38 of the braking system 12 (i.e., a “brake bedding request”) has been received and/or is active. In an embodiment, such a request may be input or initiated by a user of the vehicle 10 through one of the user interface device(s) 24, and may input or initiate a brake bedding request for a number of reasons.

One reason may be that the user (e.g., driver) intends on operating the vehicle 10 in a manner in which the frictional braking devices 38 of the braking system 12 are likely to be called upon to apply a braking torque to one or more axles of the vehicle 10, and the user wants to make sure those braking devices 38 are prepared for such use. This may include, for example, when a driver takes the vehicle 10 to a race track or race course where the vehicle 10 will be operated in a dynamic manner requiring the heavy use of the regenerative braking devices 36 and/or the frictional braking devices 38. Similarly, if the driver intends to couple the vehicle 10 to a trailer and tow it on a journey across undulating or mountainous terrain, the driver may opt to prepare the vehicle 10 before the journey by ensuring the frictional braking devices 38 are optimally bedded-in before the planned journey towing the trailer.

Another reason may be that the brake pad lining(s) of one or more frictional braking devices 38 is/are green, that is to say new/unused. As described in the Background above, a bedding-in process is typically required to be performed on green linings to ensure that that a frictional braking device having such a lining operates optimally and efficiently. Accordingly, if the vehicle is new and has one or more green linings, or if a service was recently performed on the vehicle to replace one or more worn brake pad linings, a user (e.g., a driver, service technician, dealer personnel, factory/manufacturer personnel) may input a brake bedding request via a suitable user interface device 24 or by resetting a warning condition or indicator of vehicle 10 (e.g., a brake warning indicator) using known techniques.

It will be appreciated that while particular reasons have been provided for why a user may input or initiate a brake bedding request, the present invention is not intended to be limited only to those reasons; rather brake bedding requests may be input or initiated by a user for any number of reasons in addition to or in lieu of those described herein.

In another embodiment, rather than a brake bedding request being input or initiated by a user, such a request may be input or initiated by a system of the vehicle 10, and may input or initiate a brake bedding request for a number of reasons.

One reason may be that one or more other predetermined conditions, including, but not limited to, one or more of those described below, are met. More particularly, if it is determined that all or at least a particular combination of predetermined conditions are met, a system of the vehicle 10 (e.g., the controller 18 of the braking system 12) may automatically, and without any user input or involvement, initiate a brake bedding request. Accordingly, if a condition evaluated in step 104 is that a vehicle system-initiated brake bedding request has been received, and it is determined that such a request has, in fact, been received, it can be determined in step 104 that this particular condition is met.

Whether the condition relates to a user-initiated or a vehicle system-initiated brake bedding request, in an embodiment, this condition may be evaluated by, and thus step 104 may be performed by, the controller 18 of the braking system 12 (e.g., the controller 18 may be configured to determine whether a such request has been received at an input 30 thereof); though in other embodiments, another component of the braking system 12 or the vehicle 10 may be utilized.

Another condition that may be evaluated is whether the braking system 12 of the vehicle 10 is operating in a particular mode of operation. More particularly, and as was briefly described above, the braking system 12 may be configured to operate in a plurality of modes of operation. One such mode may be a factory or service mode that may be enabled during manufacture of the vehicle and/or at a dealer or service facility (e.g., for a new vehicle or a vehicle for which maintenance is performed on the braking system). Once the “factory” mode is enabled, it remains active until it is either disabled manually by a user (e.g., driver, service technician, dealer or manufacturer personnel, etc.), or automatically upon certain criteria being met indicative of a bedding-in process performed on one or more of the frictional braking devices 38 having been completed. Accordingly, if a condition evaluated in step 104 is that the braking system 12 of the vehicle is operated in the aforedescribed factory mode, and it is determined that the factory mode is, in fact, enabled or active, it can be determined that this particular condition is met. In an embodiment, this condition may be evaluated by, and thus step 104 may be performed by, the controller 18 of the braking system 12, since the controller 18 is would be aware of the mode in which the braking system 12 is operating. Other conditions that may be evaluated relate to whether one or more particular events have occurred less than a certain number of times following, for example, the installation of green brake pad lining(s) on the vehicle 10. More particularly, through empirical testing, it can be determined how many times a particular event typically occurs before green brake pad linings are considered to be sufficiently and/or acceptably bedded-in. Any number of events may be taken into consideration, including, for example and without limitation, the starting of the vehicle (e.g., ignition cycles) and/or the number of times some or all of the frictional braking devices 38 of the frictional braking subsystem 22 has/have been actuated. In an embodiment, empirically-derived threshold value(s) for one or more events of interest may be stored in a suitable electronic memory device (e.g., the memory device 34 of the controller 18 of the braking system 12) during, for example, the manufacture of the vehicle 10. The threshold value(s) may be static, non-adjustable value(s); or alternatively may be adjustable by an authorized person (e.g., a service technician, dealer personnel, manufacturer personnel, etc.). As will be described below, the stored threshold value(s) may be used in determining whether one or more conditions have/has been met.

In an embodiment wherein an “event-related” condition is evaluated in step 104, step 104 may comprise a first substep of determining the number of times the event(s) of interest has/have thus far occurred following, for example, the installation of green brake pad lining(s), and a second substep of comparing the number determined in the first substep to one or more respective threshold values.

As it relates to the first substep, in an embodiment, the component configured to perform step 104 (e.g., the controller 18 of the braking system 12) may be configured to maintain a log to track the occurrence(s) of the event(s) of interest based on information received from one or more sensors or systems of the braking system 12 or the vehicle 10, and to then use that log to determine the number of times the event(s) has/have occurred. In such an embodiment, the information used to log the occurrence(s) of the event(s) of interest may be automatically received or may be received in response to a polling request to provide the information. For example, if an event of interest comprises an ignition cycle of the vehicle 10 and the controller 18 of the braking system 12 is configured to perform step 104, a sensor or system/component of the vehicle 10 (e.g. a VCU, an ignition system/module, etc.) configured to detect the starting of the vehicle 10 may output a signal indicative of an ignition event that is received by the controller 18 and recorded in log stored in a suitable electronic memory device (e.g., the memory device 34). If an event of interest includes the number of times a frictional braking device 38 of the braking system 12 has been actuated and the controller 18 is configured to perform step 104, either the controller 18 can log when that braking device has been actuated based whether the controller 18 has commanded the actuation of the device, or a sensor configured to detect, for example, the actuation of the braking device (e.g., a brake torque sensor associated with the braking device) may output a signal indicative of an actuation of the braking device that is received by the controller 18 and recorded in a log stored in a suitable electronic memory device (e.g., the memory device 34). In any event, each time a brake command is received, the appropriate log(s) may be consulted to determine the number of times the event(s) of interest have occurred.

In another embodiment, rather than the component that is configured to perform step 104 (e.g., the controller 18 of the braking system 12) maintaining one or more logs to determine the number of times the event(s) of interest has/have occurred, the component performing step 104 may poll another system of the vehicle 10 to determine the number of times the event(s) has/have occurred. For example, in an embodiment wherein the controller 18 is configured to perform step 104, the controller 18 may poll, for example, the VCU of the vehicle 10 or another system thereof (e.g., ignition system or module, powertrain system, etc.) to obtain the number of times the event(s) has/have occurred.

Accordingly, it will be appreciated that the number of times a particular event has occurred may be determined in a number of ways, and as such, the present invention is not limited to any particular way(s) of doing so.

As it relates to the second substep, in an embodiment, the threshold value(s) corresponding to the event(s) of interest being evaluated may be accessed from an electronic memory device in which the threshold value(s) is/are stored (e.g., the memory device 34 of the controller 18), and then the number(s) of occurrences determined in the first substep may be compared to that or those respective thresholds. If, for a particular event of interest, the determined number of occurrences is above (or, in an embodiment, meets or is above) the threshold value to which it was compared, it can be determined that the condition is not met. If, however, the determined number of occurrences of a particular event of interest is below (or, in an embodiment, meets or is below) the threshold value to which it was compared, it can be determined that the condition is met.

As will be appreciated in view of the above, in an embodiment, conditions relating to whether a particular event has occurred less than a certain number of times may be evaluated by the controller 18 of the braking system 12, and thus, step 104 may be performed by the controller 18. It will be appreciated, however, that in other embodiments, another component of the braking system 12 or the vehicle 10 may be utilized in conjunction with or instead of the controller 18.

Yet another condition that may be evaluated is whether the vehicle 10 has driven less than a particular distance following, for example, the installation of green brake pad lining(s) on the vehicle. More particularly, through empirical testing, it can be determined what distance a vehicle typically travels before green brake pad linings are considered to be sufficiently and/or acceptably bedded-in. In an embodiment, an empirically-derived distance (e.g., miles or kilometers) threshold value may be stored in a suitable electronic memory device (e.g., the memory device 34 of the controller 18 of the braking system 12) during, for example, the assembly or manufacture of the vehicle 10. The threshold value may be static, non-adjustable value; or alternatively may be adjustable by an authorized person (e.g., a service technician, dealer personnel, manufacturer personnel, etc.). As will be described below, the stored threshold value may be used in determining whether a condition relating to distance travelled by the vehicle 10 has been met.

In an embodiment wherein a “distance travelled” condition is evaluated in step 104, step 104 may comprise a first substep of determining the distance the vehicle 10 has thus far travelled following, for example, the installation of green brake pad lining(s), and a second substep of comparing the distance travelled determined in the first substep to a threshold value.

As it relates to the first substep, in an embodiment, the component configured to perform step 104 (e.g., the controller 18 of the braking system 12) may be configured to monitor and/or maintain a log the distance the vehicle 10 has traveled based on information received from one or more sensors or systems of the vehicle 10, and to then use that log to determine the distance traveled upon the receipt of a brake command in step 102. In such an embodiment, the information used to log the distance travelled may be automatically received or may be received in response to a polling request to provide the information. For example, if the controller 18 of the braking system 12 is configured to perform step 104, a sensor or system/component of the vehicle 10 (e.g. the VCU, an odometer module, a sensor at a wheel of the vehicle 10, etc.) configured to detect or monitor distance or a parameter that may be used to derive distance travelled, may output a signal that is received by the controller 18. The controller 18 may record the information represented by the received signal(s) in a log stored in a suitable electronic memory device (e.g., the memory device 34 of the controller 18).

In another embodiment, rather than the component that is configured to perform step 104 (e.g., the controller 18 of the braking system 12) maintaining or logging distance travelled by the vehicle 10, the component performing step 104 may poll another system of the vehicle 10 to determine the distance travelled thus far. Accordingly, it will be appreciated that the distance travelled by the vehicle 10 may be determined in a number of ways, and as such, the present invention is not limited to any particular way(s) of doing so.

As it relates to the second substep, in an embodiment, the threshold value is accessed from the electronic memory device in which the threshold value is stored (e.g., the memory device 34 of the controller 18), and then the distance travelled determined in the first substep is compared to that threshold value. If the distance travelled is above (or, in an embodiment, meets or is above) the threshold value, it can be determined that the condition is not met; if, however, the distance travelled is below (or, in an embodiment, meets or is below) the threshold value, it can be determined that the condition is met.

As will be appreciated in view of the above, in an embodiment, a condition relating to whether the vehicle 10 has travelled less than a certain distance may be evaluated by the controller 18 of the braking system 12, and thus, step 104 may be performed by the controller 18. It will be appreciated, however, that in other embodiments, one or more other components of the braking system 12 or the vehicle 10 may be utilized in conjunction with or instead of the controller 18.

A further condition that may be evaluated relates to an amount of work performed or generated at the linings of one or more of the frictional braking devices following, for example, the installation of green brake pad lining(s) on the vehicle 10. More particularly, in an embodiment, a condition may be that a calculated amount of work performed or generated at or by a particular frictional braking device, or by a totality of the frictional braking devices of a frictional braking system, is below (or, in an embodiment, meets or is below) a particular threshold value. Accordingly, in response to the brake command received in step 102, one or more calculations can be performed to determine an amount of work that has been performed by or at one or more frictional braking devices on either a system-wide or an individual frictional braking device basis.

In an embodiment, the calculation(s) may take into account, for example, the duration (e.g., time or distance) of a braking event and the pressure/force of that event to provide an amount of work generated or performed at the lining(s) of one or more of the frictional braking devices 38. The result(s) of that or those calculations may then be compared to one or more predetermined, empirically-derived threshold value(s) representative of an amount of work that is deemed necessary or sufficient to sufficiently or acceptably bed-in frictional braking device linings. Based on the comparison, a determination can be made as to whether the amount of work done by or at one or more of the frictional braking devices, and therefore, the lining(s) thereof, is sufficient for the lining(s) to be considered sufficiently or acceptably bedded-in. In an embodiment, the empirically-derived “work” threshold value(s) may be stored in a suitable electronic memory device (e.g., the memory device 34 of the controller 18 of the braking system 12) during, for example, the manufacture or assembly of the vehicle 10. The threshold value(s) may be static, non-adjustable value(s); or alternatively may be adjustable by an authorized person (e.g., a service technician, dealer personnel, manufacturer personnel, etc.). As will be described below, the stored threshold value(s) may be used in determining whether one or more conditions have/has been met.

In an embodiment wherein a work-based calculation condition is evaluated in step 104, step 104 may comprise a first substep of performing the requisite calculation(s) for one or more individual frictional braking devices or for the frictional braking subsystem 22 as a whole; and a second substep of comparing the result(s) of the calculation(s) performed in the first substep to one or more respective threshold values.

As it relates to the first substep, in an embodiment, the component configured to perform step 104 (e.g., the controller 18 of the braking system 12) may be configured to perform a system-wide work-based calculation for the frictional braking subsystem 22 using, for example, a suitable equation such as equation (1):

work_{system}=c×d×e, (1)

where: c is the applied force (which can be determined by multiplying the brake system pressure a by the sum b of the areas of the brake caliper pistons associated with each of the frictional braking devices 38 (i.e., c=a×b); d is the total friction of the brake pads of the frictional braking devices; and e is the distance travelled by the vehicle, and the work calculation is in terms of Joules (J).

In another embodiment, the component configured to perform step 104 (e.g., the controller 18 of the braking system 12) may be configured to perform a work-based calculation for one or more individual frictional braking devices 38 of subsystem 22 using, for example, an suitable equation such as equation (2):

work_{device}=h×i×j×k, (2)

where: h is the force applied by the braking device 38 (which can be determined by multiplying the brake pressure f at the braking device by the area g of the brake caliper piston of the braking device (i.e., h=f×g); i is the rotation of the wheel associated with the frictional braking device; j is the friction of the brake pads of the braking device; and k is the radius of application, and the work calculation is in terms of Joules (J).

Whether the work-based calculation is a system-wide calculation or an individual device calculation, the values of the parameters used in the calculation may be acquired from a memory device (e.g., memory device 34 of the controller 18), may be measured by one or more sensors of the vehicle 10, and/or may be acquired from another system/component of the vehicle 10 (e.g. a VCU).

As it relates to the second substep, in an embodiment, the threshold value(s) may be accessed from an electronic memory device in which the threshold value(s) is/are stored (e.g., the memory device 34 of the controller 18), and then the result(s) of the calculation(s) performed in the first substep may be compared to that or those respective thresholds. If it is determined that the result(s) of all of the calculations performed in the first substep is above (or, in an embodiment, meets or is above) the threshold value to which it was compared, it can be determined that the condition is not met. If, however, a result of a calculation performed in the first substep is below (or, in an embodiment, meets or is below) the threshold value to which it was compared, it can be determined that the condition is met.

As will be appreciated in view of the above, in an embodiment, a work-based calculation condition may be evaluated by the controller 18 of the braking system 12, and thus, step 104 may be performed by the controller 18. It will be appreciated, however, that in other embodiments, another component of the braking system 12 or the vehicle 10 may be utilized in conjunction with or instead of the controller 18. Still another condition that may be evaluated is whether the vehicle 10 is traversing a particular type of terrain (e.g., off-road terrain or on-road terrain). In an embodiment, the component configured to perform step 104 (e.g., the controller 18 of the braking system 12) may be configured to determine the prevailing terrain type, and to then compare that determined type to one or more terrain types stored in an electronic memory device (e.g., the memory device 34 of the controller 18) for which the performance of a bedding-in process was previously determined to be appropriate to determine whether the condition is met.

The prevailing terrain type may be determined in a number of ways. For example, in an embodiment the component configured to perform step 104 (e.g., the controller 18 of the braking system 12) may be configured to determine the type of terrain being traversed using information received from one or more sensors and/or systems of vehicle 10 and well known techniques for processing or evaluating that information to determine terrain type, such as, for example, that or those described in UK Published Application No. GB2492748A published on 16 Jan. 2013, the entire contents of which are incorporated herein by reference. In another embodiment, the prevailing terrain type may be determined by a system of the vehicle 10 other than that configured to perform step 104, and the determined terrain type may then be communicated to the component configured to perform step 104 either automatically or in response to a request to do so. In yet another embodiment, the prevailing terrain type may be determined in dependence on a user input made via one or more of the user input device(s) 24.

In any event, once the prevailing terrain type is determined, it may be compared to one or more predetermined terrain types that have been identified as terrain types for which a bedding-in process is to be performed or enabled that may be contained within a lookup table or other data structure stored in or on an electronic memory device (e.g., the memory device 34 of the controller 18). If the prevailing terrain type matches a terrain type to which it was compared, it can be determined that the condition is met; otherwise, it can be determined that the condition has not been met.

A further condition that may be evaluated is whether the vehicle 10 is operating (or at least certain systems thereof are operating) in a particular operating mode, for example, a particular terrain response mode. In an embodiment, the component or system configured to perform step 104 (e.g., the controller 18 of the braking system 12) is configured to receive information that may be used to determine the particular operating mode in which the vehicle 10 is being operated. This may include, for example, receiving a user input via one or more of the user interface device(s) 24 indicative of a desired operating mode, or receiving an indication from another system or component of the vehicle 10 (e.g., a VCU) relating to the operating mode. This information may be automatically sent or communicated, or may be sent in response to a request to do so. In any event, once the prevailing operating mode of the vehicle 10 is determined, it may be compared to one or more predetermined operating modes that have been identified as operating modes for which a bedding-in process is to be performed or enabled that may be contained within a lookup table or other data structure stored in or on an electronic memory device (e.g., the memory device 34 of the controller 18). If the prevailing operating mode matches a mode to which it was compared, it can be determined that the condition is met; otherwise, it can be determined that the condition has not been met.

As with the other conditions that may be evaluated in step 104, it will be appreciated that a condition relating to either the prevailing terrain being a particular type of terrain, and/or the vehicle operating in a particular operating mode may be evaluated by the controller 18 of the braking system 12, and thus, step 104 may be performed by the controller 18. It will be appreciated, however, that in other embodiments, another component of the braking system 12 or the vehicle 10 may be utilized in conjunction with or instead of the controller 18.

It will be appreciated that while several examples of conditions that may be evaluated in step 104 have been identified and at least generally described above, the present invention is not limited to the use of any particular condition(s), as any suitable or appropriate conditions may be used in addition to or in lieu of one or more of those described above.

It will be further appreciated that the particular condition(s) that is/are evaluated in step 104 may be implementation-specific. For example, in one implementation a single condition may be evaluated; while in another implementation, a combination of conditions may be evaluated. Accordingly, the present disclosure is not intended to be limited to any particular number of condition(s) being evaluated in step 104, as any number of conditions may be used.

Turning back to FIG. 3, if it is determined in step 104 that the one or more conditions being evaluated is/are met, or, in an embodiment, that at least certain of the evaluated condition(s) (e.g., one or more but less than all) is/are met, method 100 may proceed to a step 106 of inhibiting the operation of at least one regenerative braking device that is operatively coupled to an axle of the vehicle, and actuating at least one frictional braking device that is also operatively coupled to an axle of the vehicle in order to carry out the brake command received in step 102 and also perform a bedding-in process on one or more brake pad lining(s) of the actuated frictional braking device(s).

In an embodiment, step 106 comprises inhibiting the operation of all of the regenerative braking devices 36 of the regenerative braking subsystem 20. In another embodiment, however, step 106 comprises inhibiting the operation of less than all of the regenerative braking devices 36. In the latter instance, only the regenerative braking device(s) 36 associated with a particular axle of the vehicle 10 may be inhibited (e.g., the regenerative braking devices operatively coupled to the axle to which the frictional braking devices 38 having green brake pad linings are also operatively coupled), or only the regenerative braking devices located at one or more particular locations (e.g., corners) of the vehicle 10 (e.g., proximate one or more wheels of the vehicle 10) may be inhibited (e.g., the regenerative braking device(s) proximate one or more locations (e.g., corners) of the vehicle 10 at which frictional braking device(s) having green brake pad lining(s) are also disposed). Accordingly, the present invention is not limited to any one particular scheme for inhibiting operation of one or more of the regenerative braking devices 36 of the regenerative braking subsystem 20.

As briefly described above, step 106 also comprises actuating one or more of the frictional braking devices 38 of the braking system 12. In an embodiment, all of the frictional braking devices 38 of the frictional braking subsystem 22 are actuated. In another embodiment, however, less than all of the frictional braking devices 38 are actuated. In the latter instance, only the frictional braking devices 38 that have green brake pad lining(s) may be actuated; or only the frictional braking devices 38 that have green brake pad lining(s) and those that are operatively coupled to the same axle of the vehicle 10 as that or those devices 38 having green brake pad lining(s) may be actuated. Accordingly, the present invention is not limited to any one particular scheme for actuating one or more of the frictional braking devices 38 of the frictional braking subsystem 22.

In any event, inhibiting the operation of one or more of the regenerative braking devices may be carried out or performed in a number of ways. In an embodiment wherein the controller 18 is configured to directly control the operation of the regenerative braking devices 36 of the braking system 12, the controller 18 may simply not send an actuation signal to the regenerative braking devices 36 whose operation is being inhibited. In an embodiment wherein the regenerative braking subsystem 20 has a dedicated control unit, the controller 18 may either not send a command signal to the control unit, or may send a command signal to the control unit with instructions as to which of the regenerative braking devices 36 are to be actuated (if any) and which are to be inhibited. The control unit may then actuate the appropriate regenerative braking device(s) 36 accordingly.

Similarly, actuating one or more of the frictional braking devices 38 may be carried out in a number of ways. In an embodiment wherein the controller 18 is configured to directly control the operation of the frictional braking devices 38, the controller 18 may simply send an actuation signal to the frictional braking device(s) 38 that are to be actuated (e.g., all or some of the frictional braking devices). In an embodiment wherein the frictional braking subsystem 22 has a dedicated control unit, the controller 18 may send a command signal to the control unit with instructions as to which of the frictional braking device(s) 38 are to be actuated and which are not. The control unit may then actuate the appropriate frictional braking device(s) 38 accordingly.

It will be appreciated that the present disclosure is not intended to be limited to any particular way(s) of inhibiting and actuating, respectively, the regenerative and frictional braking devices of the braking system 12; rather any suitable way of doing so may be used.

It will be understood that the embodiments described above are given by way of example only and are not intended to limit the invention, the scope of which is defined in the appended claims. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Further, the terms “electrically connected” or “electrically coupled” and the variations thereof are intended to encompass both wireless electrical connections and electrical connections made via one or more wires, cables, or conductors (wired connections). Other terms are to be construed using their broadest reasonable meaning unless they are used in a context that requires a different interpretation.

1. A method of operating a vehicle braking system comprising one or more frictional braking devices and one or more regenerative braking devices, the method comprising:
receiving at least one electrical signal indicative of a brake command;
determining whether one or more predetermined conditions are met in response to the received brake command, wherein at least one of the predetermined condition(s) comprises a condition pertaining to the one or more frictional braking devices; and
when at least certain of the one or more predetermined conditions are met, inhibiting the operation of at least one of the one or more regenerative braking devices and actuating at least one of the one or more frictional braking devices in order to carry out the received brake command and to bed-in brake pad lining(s) of the actuated frictional braking device(s),
wherein the one or more predetermined conditions comprise(s) a calculated amount of work generated by at least one of the one or more frictional braking devices being below a predetermined threshold value.

2. The method of claim 1, wherein the one or more predetermined conditions comprise(s) a brake bedding request having been received.

3. The method of claim 2, wherein the brake bedding request comprises a user-initiated request initiated by an occupant of the vehicle or as a result of service performed on the vehicle.

4. The method of claim 1, wherein the one or more predetermined conditions comprise(s) the braking system being operated in a particular mode of operation.

5. The method of claim 4, wherein the mode of operation comprises a factory- and/or service-enabled mode of operation.

6-9. (canceled)

10. The method of claim 1, wherein inhibiting the operation of at least one of the one or more regenerative braking devices comprises one of:
inhibiting the operation of all of the one or more regenerative braking devices;
inhibiting the operation of less than all of the one or more regenerative braking devices; or
inhibiting the operation of the regenerative braking devices associated only with a particular axle of the vehicle.

11. A non-transitory, computer-readable storage medium storing instructions thereon that when executed by one or more electronic processors causes the one or more electronic processors to carry out the method of claim 1.

12. A system for controlling the operation of a vehicle braking system comprising one or more frictional braking devices and one or more regenerative braking devices, the system comprising:
means for receiving one or more electrical signals indicative of a brake command;
means for determining whether one or more predetermined conditions are met in response to the received brake command, wherein at least one of the predetermined condition(s) comprises a condition pertaining to the one or more frictional braking devices; and
means for automatically commanding that the operation of at least one of the one or more regenerative braking devices be inhibited and that at least one of the one or more frictional braking devices be actuated when at least certain of the one or more predetermined conditions are met in order to carry out the received brake command and to bed-in brake pad lining(s) of the actuated frictional braking device(s).

13. The system of claim 12, wherein the receiving, determining, and commanding means comprise:
an electronic processor having one or more electrical inputs; and
an electronic memory device electrically coupled to the electronic processor and having instructions stored therein,
wherein the processor is configured to access the memory device and execute the instructions stored therein such that it is configured to:
receiving the one or more electrical signals indicative of a brake command;
determine whether the one or more predetermined conditions are met in response to the received brake command, wherein at least one of the predetermined condition(s) comprises a condition pertaining to the one or more frictional braking devices; and
automatically command that the operation of the at least one of the one or more regenerative braking devices be inhibited and that the at least one of the one or more frictional braking devices be actuated when at least certain of the one or more predetermined conditions are met in order to carry out the received brake command and to bed-in brake pad lining(s) of the actuated frictional braking device(s),
wherein the one or more predetermined conditions comprise(s) a calculated amount of work generated at by least one of the one or more frictional braking devices being below a predetermined threshold value.

14. The system of claim 12, wherein the one or more predetermined conditions comprise(s) a brake bedding request having been received.

15. The system of claim 12, wherein the one or more predetermined conditions comprise(s) the braking system being operated in a particular mode of operation.

16-18. (canceled)

19. The system of claim 12, wherein inhibiting the operation of at least one of the one or more regenerative braking devices comprises:
inhibiting the operation of all of the one or more regenerative braking devices;
inhibiting the operation of less than all of the one or more regenerative braking devices; or
inhibiting the operation of the regenerative braking devices associated only with a particular axle of the vehicle.

20. An electronic controller for a vehicle having a storage medium associated therewith storing instructions that when executed by the controller causes a vehicle braking system having one or more regenerative braking devices and one or more frictional braking devices to be operated in accordance with the method of:
receiving one or more electrical signal indicative of a brake command;
determining whether one or more predetermined conditions are met in response to the received brake command, wherein at least one of the predetermined condition(s) comprises a condition pertaining to the one or more frictional braking devices; and
when at least certain of the one or more predetermined conditions are met, inhibiting the operation of at least one of the one or more regenerative braking devices and actuating at least one of the one or more frictional braking devices in order to carry out the received brake command and to bed-in brake pad lining(s) of the actuated frictional braking device(s).

21. A vehicle, comprising:
a braking system having one or more regenerative braking devices and one or more frictional braking devices;
a system for controlling the operation of a vehicle braking system comprising one or more frictional braking devices and one or more regenerative braking devices, the system comprising:
means for receiving one or more electrical signals indicative of a brake command;
means for determining whether one or more predetermined conditions are met in response to the received brake command, wherein at least one of the predetermined condition(s) comprises a condition pertaining to the one or more frictional braking devices; and
means for automatically commanding that the operation of at least one of the one or more regenerative braking devices be inhibited and that at least one of the one or more frictional braking devices be actuated when at least certain of the one or more predetermined conditions are met in order to carry out the received brake command and to bed-in brake pad lining(s) of the actuated frictional braking device(s).

22-23. (canceled)
